(19) United States
(12) Patent Application Publication
(10) Pub. No.: US 2019/0251849 A1
(43) Pub. Date: Aug. 15, 2019

(54) SHIP COLLISION AVOIDANCE METHOD USING PSYCHOLOGICAL CHARACTER OF SHIP OFFICER

(71) Applicant: Mokpo National Maritime University Industry- Academic Cooperation Foundation, Mokpo-si (KR)

(72) Inventors: JaeYong Jeong, Muan-gun (KR); JeongBin YIM, Busan (KR); DeukJin Park, Mokpo-si (KR)

(73) Assignee: Mokpo National Maritime University Industry- Academic Cooperation Foundation, Mokpo-si (KR)

(21) Appl. No.: 16/026,025

(22) Filed: Jul. 2, 2018

(30) Foreign Application Priority Data
Feb. 12, 2018 (KR) 10-2018-0016715

(51) Int. Cl. G08G 3/02; B63B 49/00; B63B 43/18; G06F 17/30

(52) U.S. Cl. CPC G08G 3/02; G06F 17/30241; B63B 43/18; B63B 49/00

(57) ABSTRACT

The present invention relates to a ship collision avoidance method using a psychological character of a ship officer that can provide support allowing ships to avoid collision between one another by using the psychological character of ship officers in order to prevent marine accidents. Herein, a ship collision avoidance method using the psychological character of a ship officer may include a first step calculating a relative distance (RD) and a relative bearing (RB) between two ships by using information of a main ship and information of an opposite ship, a second step estimating a collision risk level (or collision level) (CL) corresponding to the relative distance (RD) and the relative bearing (RB) by using a collision risk (CR) perception of the ship officer, and modeling a Collision Risk Estimation Model (CREM) that converts the estimated results to three-dimensional (3D) coordinate data, a third step calculating a distance of a ship domain (DSD) and the collision level (CL) using the modeled Collision Risk Estimation Model (CREM), a fourth step deciding a reference value of a spatial aspect corresponding to a reference distance for determining a presence of a collision risk between two ships and a reference value of a psychological aspect corresponding to a collision level (CL) for determining a presence of a collision risk between two ships, and a fifth step comparing the relative distance (RD) with the reference value corresponding to the spatial aspect, so as to generate a ship domain (SD) warning for notifying the ship officers that the two ships are within a distance of a possible collision, or comparing a collision risk corresponding to the relative distance (CL(RD)) with the reference value corresponding to the psychological aspect, so as to generate a collision risk (CR) warning for notifying the ship officers that the collision level has reached a level of collision risk.

This application claims the benefit of the Korean Patent Application No. 10-2018-0016715, filed on Feb. 12, 2018, which is hereby incorporated by reference as if fully set forth herein.

### BACKGROUND OF THE INVENTION

### Field of the Invention

The present invention relates to a ship collision avoidance method using a psychological character of a ship officer that can provide support allowing ships to avoid collision between one another by using the psychological character of ship officers in order to prevent marine accidents.

### Discussion of the Related Art

Presently, ships are capable of detecting (or sensing) risks of ship collision by using diverse electronic navigation equipment, such as Automatic Radar Plotting Aids/Radar (ARPA/Radar), an Electric Chart Display and Information System (ECDIS), an Automatic Identification System (AIS), and so on.

Based on a Ship Domain (SD) theory, a Distance at the Closest Point of Approach (DCPA) and a Time to the Closest Point of Approach (TCPA) between ships are used for evaluating a collision risk between ships.

However, a ship collision avoidance method using the ship domain theory and the DCPA and TCPA have numerous problems and disadvantages that are yet to be resolved.

Moreover, even though diverse navigation equipment is used for avoiding (or preventing) collision, marine collision accidents are still occurring very frequently. This is because the psychological character (most particularly, a sense of crisis (or danger) of a possible collision that is sensed during a situation of ship collision) of an Officer on the Watch (OOW) operating the ship (or vessel) is not taken into consideration.

Generally, when a dangerous situation occurs or is expected to occur, a human being naturally senses and perceives the imminent crisis. However, the level of crisis perception may differ for each individual.

In a situation where a collision between two ships occurs, the OOW is known to perceive a collision risk (CR).

And, in an encounter situation where a collision between two ships is likely (or possible) to occur, the OOW operating (or handling) the ship is expected and required to perform a series of operations (or actions) for avoiding the collision according to the Convention on the International Regulations for Preventing Collisions at Sea (COLREG).

Meanwhile, it has been reported that 70% or more of the marine accidents occurring worldwide is caused by human errors. The International Maritime Organization (IMO) has also recognized the gravity of such human errors and is now carrying out diverse actions for preventing such critical human errors.

In case a ship collision situation occurs, the CR that is perceived by the OOW plays a very important and critical role in preventing human errors. This is because, by analyzing the CR, characteristics of diverse collision situations that are perceived by an individual OOW or a specific OOW group may be derived, thereby allowing a solution for preventing marine accidents that are caused by human errors to be devised.

However, in the related art, research on the human errors that are made by OOWs mostly consists of research on the causes of the human errors and the classification of such causes. Currently, there is no research that can be applied to ships that are actually navigating at sea. This is because it is extremely difficult and dangerous to perform experiments on ships and OOWs that are actually navigating at sea. And, even if such experiments are carried out, it would require a considerable amount of experiment cost. For such reasons, there currently exists no research applying the CR perceived by OOWs to actual ships for collision avoidance or collision prevention.

### SUMMARY OF THE INVENTION

An object of the present invention, which has been devised to overcome the above-described problems and disadvantages, is to provide a ship collision avoidance method using the psychological character of a ship officer that can support avoidance (or prevention) of a ship collision by using a sense of danger felt by an officer on the watch (OOW) upon an imminent collision when encountering a ship collision situation and by using the ship domain theory.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

In order to achieve the above-described technical object of the present invention, the ship collision avoidance method using the psychological character of a ship officer according to the present invention may include a first step calculating a relative distance (RD) and a relative bearing (RB) between two ships by using information of a main ship and information of an opposite ship, a second step estimating a collision risk level (or collision level) (CL) corresponding to the relative distance (RD) and the relative bearing (RB) by using a collision risk (CR) perception of the ship officer, and modeling a Collision Risk Estimation Model (CREM) that converts the estimated results to three-dimensional (3D) coordinate data, a third step calculating a distance of a ship domain (DSD) and the collision level (CL) using the modeled Collision Risk Estimation Model (CREM), a fourth step deciding a reference value of a spatial aspect corresponding to a reference distance for determining a presence of a collision risk between two ships and a reference value of a psychological aspect corresponding to a collision level (CL) for determining a presence of a collision risk between two ships, and a fifth step comparing the relative distance (RD) with the reference value corresponding to the spatial aspect, so as to generate a ship domain (SD) warning for notifying the ship officers that the two ships are within a distance of a possible collision, or comparing a collision risk corresponding to the relative distance (CL(RD)) with the reference value corresponding to the psychological aspect, so as to generate a collision risk (CR) warning for notifying the ship officers that the collision level has reached a level of collision risk.

Preferably, in the fourth step, a distance of a ship domain (DSD) corresponding to the relative bearing (RB) may be decided as the reference value corresponding to the spatial aspect, and, among the collision levels (CLs) estimated by the Collision Risk Estimation Model (CREM), a collision level (CL) corresponding to a distance of a ship domain (DSD) (CL(DSD)) corresponding to the relative bearing (RB) may be decided as the reference value corresponding to the psychological aspect.

Preferably, in the fifth step, the relative bearing (RB) may be compared with the reference value corresponding to the spatial aspect, and, if the relative distance (RD) is greater than the reference value corresponding to the spatial aspect, the ship domain (SD) warning may be generated.

Preferably, in the fifth step, the collision risk corresponding to the relative distance (RD) (CL(RD)) may be compared with the reference value corresponding to the psychological aspect, and, if the reference value corresponding to the psychological aspect is greater than the collision risk corresponding to the relative distance (RD) (CL(RD)), the collision risk (CR) warning may be generated.

Preferably, in the second step, input variables of the Collision Risk Estimation Model (CREM) may include the relative bearing (RB) and the relative distance (RD), and output variables of the Collision Risk Estimation Model (CREM) may include the collision levels (CLs) of the collision risk (CR) being estimated for consecutive relative bearings (RBs) and relative distances (RDs).

More preferably, in the second step, the output variables of the Collision Risk Estimation Model (CREM) may further include coordinate values for indicating the collision levels (CLs) on a three-dimensional (3D) hybrid map.

More preferably, in the second step, the Collision Risk Estimation Model (CREM) may estimate the collision level (CL) corresponding to the input variables by using a probability density function (pdf) of a Generalized Extreme Value (GEV).

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a diagram showing an input-output structure of a CREM in a ship collision avoidance method using a psychological character of a ship officer according to an exemplary embodiment of the present invention.

FIG. 2 illustrates a graph showing an exemplary pdf of a GEV distribution used in a CREM of a ship collision avoidance method using a psychological character of a ship officer according to an exemplary embodiment of the present invention.

FIG. 3 illustrates a graph showing a Ship Domain (SD) by using {Xdataₙ, Ydataₙ}.

FIG. 4 illustrates a graph showing ES (0≤ES≤1000) data corresponding to five different sampled ship collision encounter situations (S1˜S5).

FIG. 5 illustrates a graph showing PCR data that are measured for the five different ship collision encounter situations (S1˜S5).

FIGS. 6A and 6B illustrate a graph showing estimated results for consecutive relative bearings RBu (u=1, 2, 3, . . . , U).

FIG. 7 illustrates a graph showing a CR domain that is visualized by applying ES data and PCR data to the CREM.

FIG. 8 illustrates a graph overlapping the SD and the CR domain in order to perform a comparison between the SD and an estimated CR domain.

FIG. 9 illustrates a graph showing calculation results between a relative distance of a DSD and a CL(DSD).

FIG. 10 illustrates a graph for describing a method of configuring a warning for notifying a collision risk by using a DSD and a CL(DSD) in a ship collision avoidance method using a psychological character of a ship officer according to the present invention.

FIG. 11 illustrates a diagram showing a ship collision avoidance procedure using a psychological character of a ship officer according to an exemplary embodiment of the present invention.

### DETAILED DESCRIPTION OF THE INVENTION

Other objects, characteristics, and advantages of the present invention will be apparent based on the detailed description of the exemplary embodiment of the present invention, which will hereinafter be presented with reference to the accompanying drawings.

Hereinafter, the structure and operation of the exemplary embodiment of the present invention will be described in detail with reference to the accompanying drawings, and the description of the structure and operation of the present invention will be presented according to at least one exemplary embodiment of the present invention. And, therefore, the technical scope and spirit of the present invention and its essential structure and operation will not be limited only to the description of the exemplary embodiment presented herein.

Hereinafter, a preferred exemplary embodiment of the ship collision avoidance method using the psychological character of a ship officer will be described in detail.

The present invention uses a collision risk (CR) sensed by an officer on the watch (OOW) operating (or handling) the ship at an encounter situation where two ships are likely to collide with one another.

In order to estimate a CR, a Collision Risk Estimation Model (CREM) is used, and the CREM is configured by using the shape of a probability density function (pdf) of a Generalized Extreme Value (GEV) distribution.

Thereafter, a Collision Level (CL) respective to a relative bearing and a relative distance between two ships is estimated by using the CREM.

Subsequently, a CR domain corresponding to the estimated CL is marked on a 3-dimensional (3D) hybrid map, which is configured of a combination of 2-dimensional (2D) Cartesian coordinates (or rectangular coordinates) and polar coordinates and a 3D contour map.

A comparison is made between a collision risk (CR) domain and a ship domain (SD), and a difference between the two domains is calculated. Then, the calculated difference is configured as a reference value for determining a collision risk (CR). The configuration of the reference value will be described later on in more detail.

In the present invention, when two ships are sailing within a close range between one another, the probability of collision between the two ships may be determined by using a distance between the CL, which is to be sensed (or felt) by the OOWs, and the SD.

Herein, a CR of the OOW, which is generated when a ship approaches an encounter situation where two ships are likely to collide with one another, may be estimated by using the CL and the probability of collision is spatially indicated by using the SD and CL, which are marked on the 3-dimensional (3D) hybrid map.

As described above, the present invention uses physical elements (distance, speed, bearing, and so on) as well as factors spatializing the cognitive perception elements of a human being for avoiding collision.

The Ship Domain (SD) theory, which corresponds to one of the concepts for avoiding ship collision, is a physical concept for securing (or ensuring) a necessary and sufficient spatial domain in order to allow ships to avoid collision.

Diverse electronic navigation equipment supporting collision avoidance, such as a Radar, an Automatic Radar Plotting Aids (ARPA), an Electric Chart Display and Information System (ECDIS), and so on, is applied for the SD theory.

The present invention further applies Situation Awareness (SA) of an imminent collision, which is calculated through a CR that is perceived by an OOW, to the SD theory for calculating a spatial domain (or zone) between two or more ships, such as a Distance at the Closest Point of Approach (DCPA) and a Time to the Closest Point of Approach (TCPA), and so on. More specifically, the present invention provides support for allowing ships to avoid collision between one another by using the SD theory and the relationship between a CR and an SA.

Predicting the CR that is perceived by the OOW is very important. And, the CREM is used for predicting the CR.

The CR that is perceived by the OOW may be examined by conducting a survey or may be collected by measuring the heart rate and blood pressure of the OOW by attaching a specific device to the OOW.

Since the collected CR data corresponds to a discrete data format that has sampled a specific situation, CREM is used in order to output the consecutive input into a wanted data format.

The present invention may estimate consecutive Collision Levels (CLs) by using the discrete CR data respective to the consecutive input, and, then, the present invention may model a CREM for converting the estimated results to 3-dimensional (3D)-coordinate data.

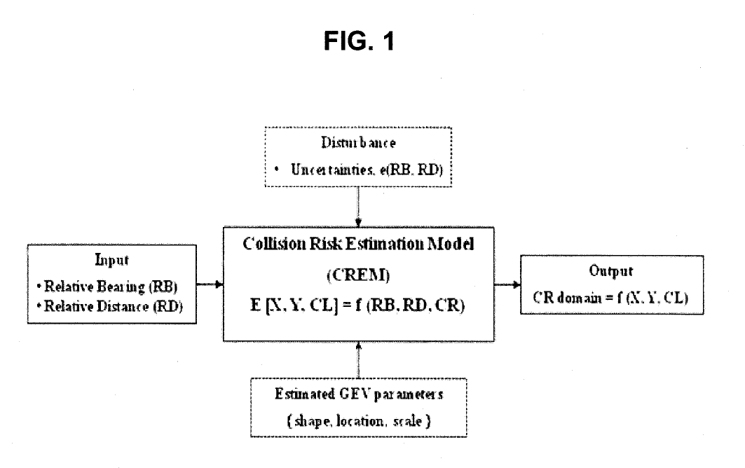

FIG. 1 illustrates a diagram showing an input-output structure of a CREM in a ship collision avoidance method using a psychological character of a ship officer according to an exemplary embodiment of the present invention.

Referring to FIG. 1, input variables of the CREM correspond to a Relative Bearing (RB) and a Relative Distance (RD), which are generated between two or more ships, and output variables of the CREM correspond to a Collision risk Level (or collision level) (CL) of a CR, which is estimated by the consecutive RB and RD, and X-coordinate values and Y-coordinate values that are used for visualizing the CL.

Most particularly, the CREM estimates the CL corresponding to the input variables by using a parameter of a Generalized Extreme Value (GEV) distribution, which is estimated in advance. At this point, the estimated result may have a predetermined level of error (or noise) corresponding to the RB and the RD.

Hereinafter, the process of modeling the CREM will be described in more detail.

Due to the characteristic of the sampled CR data, the present invention uses a probability density function (pdf) of the GEV distribution.

The pdf of the GEV distribution may be defined as a shape parameter γ, a location parameter μ, a scale parameter σ, and so on, for standard normal data χ, which are given in Equation (1) as shown below. Herein, the pdf of the GEV distribution of Equation (1) may be indicated in a more simplified format of GEVp(0≤p≤1), as shown in Equation (2).

$$\begin{matrix}GEV = f ( χ ; γ , µ , σ ) = ( 1 \text{/} σ ) exp [ - {( 1 + γ ( ( χ - µ ) \text{/} σ ) )}^{1 / γ} ] [ {( 1 + γ ( ( χ - µ ) \text{/} σ ) )}^{- 1 - ( 1 / γ )} ] , \\ ( 1 + γ ( ( χ - µ ) \text{/} σ ) > 0 ) , & ( 1 ) \\ GEVp = GEV ( χ ; γ , μ , σ ) & ( 2 )\end{matrix}$$

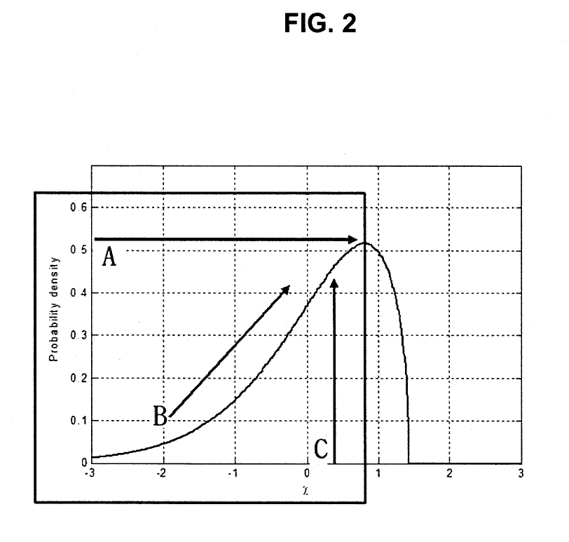

FIG. 2 illustrates an exemplary pdf of a GEV function, which is calculated by using Equation (2). This corresponds to GEVp of a case where x=−3.0˜3.0, γ=−0.7, μ=0.0, σ=1.0, and so on, are applied to Equation (2).

The rectangular box of FIG. 2 shows a left limit of the pdf (GEVp) of the GEV distribution up to only a right limit indicating a maximum probability of the pdf (GEVp) of the GEV distribution. This is to describe a method for applying the pdf of the GEV distribution to the CREM. In FIG. 2, the x-axis indicates the standard normal data x, and the y-axis indicates probability density values of the pdf of the GEV distribution.

A, B, and C, which are marked on the rectangular box shown in FIG. 2, have the following meaning. A indicates the standard normal data starting from x=˜−3.0 up to a point χ, where GEVp reaches a maximum level. B indicates an inclination of the GEVp. And, C indicates a GEVp value for χ. The present invention performs modeling of the CREM by using the three characteristics (A, B, and C), which are described above in the pdf of the GEV distribution.

The modeling of the CREM is carried out through 4 different process steps, which are described below.

Firstly, if a collision risk being measured at a relative distance (RD) of j (j=1, 2, 3, . . . , J) for each relative bearing i(i=1, 2, 3, . . . , 1) is indicated as CR_{i,j}, the CR_{i,j} corresponds to a matrix format having a dimension of I-by-J. In order to simplify the Equation of the CREM, in the CR_{i,j}, the CR for a random i value is defined as Dⱼ.

Step 1 (Curve Approximation)

A b^{th} power polynomial coefficient a(Rrⱼ), which best approaches the sample data Dⱼ that is measured from the relative distance (RD) Rrⱼ having a sequence length of j(j=1, 2, 3, . . . , J) is as shown in Equation (3), and, as shown in Equation (4), the Dₙ having a sequence length of n(n=1, 2, 3, . . . , N) may be estimated by using a(Rrⱼ).

a(Rr₁)=a₁Rrⱼ^{b}+a₂Rrⱼ^{b-1}+ . . . +a_{b}Rrⱼ+a_{(b+1)} (3)

Dₙ=a₁RDₙ^{b}+a₂RDₙ^{b-1}+ . . . +a_{b}RDₙ+a_{(b+1)} (4)

Herein, RDₙ indicates a relative distance corresponding to Dₙ and, therefore, may be calculated as RDₙ=rA+rinc−Σ₁ⁿ rinc, wherein rinc=(rA−rZ)/N. rA indicates a relative distance from a measurement start point, and rZ indicates a relative distance from a measurement end point (or a point indicating a maximum CR value).

Step 2 (Parameter Estimation of a Pdf for a GEV Distribution)

A parameter set {γ, μ, σ} of the pdf of the GEV distribution, which is optimal for Dₙ, is estimated within a search range shown in Table 1. Table 1 indicates standard normal data χ_{w} having a sequence length of w(w=1, 2, 3, . . . , W), and a search range of {γ, μ, σ} (wherein a left limit value is indicated as LT in subscript and a right limit value is indicated as RT in subscript).

By applying χ_{w} and {γ, μ, σ}, which are shown in Table 1, to Equation (2), a P_{w} of the pdf of the GEV distribution having a sequence length of w may be obtained (or calculated). Herein, as described in FIG. 2, since the pdf of the GEV distribution that is to be applied to the model estimates part of a P_{w} that can be positioned at a best approximation to Dₙ having a length of N number of sequences, a condition of W≥N is needed. The search range of Table 1 is determined by previously considering the above-described conditions. Accordingly, γ and μ are searched by fixing the μ value to μ=0.0.

TABLE 1

| | Standard normal | | | |
|---|---|---|---|---|
| | data | Shape parameter | Scale parameter | Position |
| | χ_{LT} ≤ χ_{w} ≤ χ_{RT} | γ_{LT} ≤ γ_{q} ≤ γ_{RT} | σ_{LT} ≤ σᵥ ≤ σ_{RT} | parameter μ |
| Left limits | χ_{LT} = −20.0 | γ_{LT} = −4.0 | σ_{LT} = 0.1 | μ = 0.0 |
| Right limits | χ_{RT} = 20.0 | γ_{RT} = 4.0 | σ_{RT} = 15.0 | |
| Spaces | Sχ = 0.001 | S_{γ} = 0.1 | S_{σ} = 0.1 | — |
| Index | w = 1, 2, 3, . . . , W | q = 1, 2, 3, . . . , Q | v = 1, 2, 3, . . . , V | — |

Firstly, the pdf of the GEV distribution P_{q,v,w} corresponding to a point when {γ_{q}, σᵥ} for the standard normal data χ_{w} having its sequence length w fixed to w=W is changed within the range of Table 1, is calculated by using Equation (5).

P_{q,v,w}=GEV(χ_{w=W};γ_{q},μ,σᵥ) (5)

Thereafter, a maximum value MaxP_{q,v}=max_{(1≤w≤W)}(P_{q,v,w}) of P_{q,v,w} is calculated. Then, after calculating a sequence length L_{q,v}=(|χ_{LT}˜χ_{w}(MaxP_{q,v})|)(1/S_{χ})+1 starting from a left limit χ_{LT} of χ_{w} up to χ_{w}(MaxP_{q,v}) (wherein S_{χ} indicates an interval of the sequences of χ_{w} shown in Table 1), P_{q,v,n}(n=1, 2, 3, . . . , N; N=L_{q,v}) corresponding to L_{q,v} is extracted (or calculated) by using Equation (6).

P_{q,v,n}=P_{q,v,w}=L_{q,v}) (6)

Subsequently, D_{q,v,n} (Equation (7)) corresponding to L_{q,v} is obtained (or calculated) from Dₙ of Equation (4). Then, after obtaining a maximum value MaxD_{q,v}=Max_{(1≤n≤N)}(D_{q,v,n}) of D_{q,v,n}, DP_{q,v,n} having the same value as MaxP_{q,v} is obtained by using Equation (8).

D_{q,v,n}=Dₙ(n=L_{q,v}) (7)

DP_{q,v,n}=(D_{q,v,n}/MaxD_{q,v})MaxP_{q,v} (8)

Then, a minimum relative distance MinRD_{q,v} corresponding to the length L_{q,v} respective to MaxD_{q,v} in RDₙ of Equation (4) is obtained by using Equation (9).

MinRD_{q,v}=RDₙ(MaxD_{q,v})(n=L_{q,v}) (9)

An average error err_{q,v} between P_{q,v,n} of Equation (6) and DP_{q,v,n} of Equation (8) is calculated by using Equation (10). Thereafter, \hat{q} and \hat{v} corresponding to a point when the err_{q,v} indicates a minimum value are calculated by using Equation (11).

err_{q,v}=Σₙ₌₁^{N}(|P_{q,v,n}˜DP_{q,v,n}|)/L_{q,v} (10)

{\hat{q},\hat{v}}=min_{1≤q≤Q,1≤v≤V}(err_{q,v}) (11)

More specifically, parameters of the pdf of the GEV distribution for the sample data Dⱼ, which is measured at the relative distance Rrⱼ are estimated by using Equation (3) to Equation (11).

Thereafter, the above-described parameter estimation process is repeated for the entire collision risk CR_{i,j} so as to estimate {\hat{q}ᵢ,\hat{v}ᵢ} for i by using Equation (11). Then, by using the estimated {\hat{q}ᵢ,\hat{v}ᵢ}, a GEV shape parameter \hat{γ}ᵢ=γ_{q}(q=\hat{q}ᵢ), a scale parameter \hat{σ}ᵢ=σᵥ(v=\hat{v}ᵢ), and a sequence length Lᵢ=L_{q,v} (q=\hat{q}ᵢ and v=\hat{v}ᵢ) are calculated. Then, by using the calculated results, Equation (12) to Equation (16) are calculated.

P_{i,n}=P_{q,v,n}(q=\hat{q}ᵢ,v=\hat{v}ᵢ and n=Lᵢ) (12)

DP_{i,n}=DP_{q,v,n}(q=\hat{q}ᵢ,v=\hat{v}ᵢ and n=Lᵢ) (13)

MaxDᵢ=MaxD_{q,v}(q=\hat{q}ᵢ and v=\hat{v}ᵢ) (14)

MinRDᵢ=MinRD_{q,v}(q=\hat{q}ᵢ and v=\hat{v}ᵢ) (15)

errᵢ=err_{q,v}(q=\hat{q}ᵢ and v=\hat{v}ᵢ) (16)

Step 3 (Estimated Parameter Interpolation)

Since the results estimated in the above-described Step 2 correspond to discrete relative bearings θᵢ(i=1, 2, 3, . . . , I), a model parameter for consecutive bearings RBᵤ(u=1, 2, 3, . . . , U) is required.

In the present invention, consecutive parameters are estimated by using interpolation, which will hereinafter be described in detail.

The interpolation may use a Matlab code

‘Outputs=interp1(Var1,Var2,Var3,‘pchip’)’.

‘interp1’ indicates one-dimensional (1D) interpolation, and Var1, Var2, and Var3 represent input variables. Also, ‘pchip’ indicate Piecewise Cubic Hermit (PCH) interpolation. The present invention applies the PHC interpolation in order to maintain the characteristics of the given data as much as possible.

TABLE 2

| Matlab codes | Meanings |
|---|---|
| \tilde{γ}ᵤ = interp1(θᵢ, \hat{γ}ᵢ, RBᵤ, ‘pchip’) | Interpolated GEV shape |
| | parameter |
| \tilde{σ}ᵤ = interp1(θᵢ, \hat{σ}ᵢ, RBᵤ, ‘pchip’) | Interpolated GEV scale |
| | parameter |
| Max [symbol] = interp1(θᵢ, MaxDPᵢ, RBᵤ, ‘pchip’) | Interpolated maximum DP |
| Min [symbol] = interp1(θᵢ, MinRDᵢ, RBᵤ, ‘pchip’) | Interpolated minimum RD |

Table 2 shows a Matlab code that is applied to the PHC interpolation being used for acquiring consecutive model parameters.

Step 4 (Calculation for Consecutive Bearings)

The relative bearing RBᵤ may be estimated by using the interpolation result shown in Table 2.

Firstly, the pdf \tilde{P}_{u,w} (0≤P≤1) of the GEV distribution for the standard normal data χ_{w} having a length of w number of sequences is calculated by using Equation (17), and the maximum value Max\tilde{P}_{u,w} of \tilde{P}_{u,w} is calculated by using Equation (18). And, a sequence length Lᵤ starting from a left limit χ_{LT} of χ_{w} to a point χ_{w}(Max\tilde{P}_{u,w}) corresponding to a Max\tilde{P}_{u,w} of χ_{w} is calculated by using Equation (19).

\tilde{P}_{u,w}=GEV(χ_{w};\tilde{γ}ᵤ,μ,\tilde{σ}ᵤ) (17)

Max\tilde{P}ᵤ=max_{(1≤w≤W)}(\tilde{P}_{u,w}) (18)

Lᵤ=(|χ_{LT}˜x_{w}(Max\tilde{P}ᵤ)|)(1/S_{χ})+1 (19)

\tilde{P}_{u,w} of Equation (17) calculates the \tilde{P}_{u,n}(n=1, 2, 3, . . . , N; N=Lᵤ), which corresponds to w=Lᵤ, and, by using Equation (20) shown below, [symbol] _{u,n}(0≤ [symbol] _{u,n}≤1.0) having a maximum value of 1.0 is calculated.

[symbol]

_{u,n}=((\tilde{P}_{u,n}/Max\tilde{P}ᵤ)(Max [symbol] ᵤ/MaxCR)) (20)

Herein, Max\tilde{P}ᵤ indicates a maximum value of \tilde{P}_{u,n}, and MaxCR indicates a maximum value of the collision level (CL) in the original data (or initial data).

[symbol] _{u,n} of Equation (20) corresponds to a collision level (CL) that is to be applied for visualizing the CR. Finally, a parameter set {X_{u,n}, Y_{u,n}, [symbol] _{u,n}} of 3D coordinates for forming the CR domain is calculated by using coordinate values, which are calculated by using Equation (21), and the [symbol] _{u,n}.

$$\{ \begin{matrix}{X}_{u , n} = cos ( {radRB}_{u} ) {RD}_{n} \\ {Y}_{u , n} = sin ( {radRB}_{u} ) {RD}_{n}\end{matrix} \qquad ( 21 )$$

Herein, radRBᵤ=(90−RBᵤ/180)π (radian). And, in an x-y Cartesian coordinate system, the bearing of 90° (i.e., x=0,y=+Y) is determined as the reference bearing 0°, and π=3.14.

The Ship Domain (SD) data being applied to the CREM modeling, and the Emotional Sensitivity (ES) data and the Perceived CR (PCR) data will hereinafter be described in detail.

The SD data is used for defining free space that is needed by a ship in order to avoid collision in an encounter situation of a ship collision. Herein, the SD data corresponds to distance data calculating a theoretical concept (or idea). The ES data is used for measuring a difficulty level for ship OOWs to handle (or operate) their ships in limited waters Herein, the ES data corresponds to data that is measured for an encounter situation of a ship collision by using a ship handling simulator. The PCR data is used for measuring a sense of risk that is perceived by the OOWs during a situation of an imminent collision.

The SD data corresponds to data converting a measured SD scale to distances respective to consecutive bearings. More specifically, the SD data corresponds to a data format, wherein a Phantom ship is positioned at a center (or center point) of a circle having a radius of Cr, and, then, a Real ship (or actual ship) is offset (or deviated) to a predetermined distance from the center point along the x-axis and the y-axis.

The procedure for calculating the SD data will now be described in detail.

Firstly, n number of Cartesian coordinate data sets {Xₙ,Yₙ} are calculated by using a Matlab code ‘{Xₙ,Yₙ}=pol2cart(θradₙ, Cr)’, which converts polar-coordinates to Cartesian coordinates. Herein, θradₙ indicate radian-unit bearing that is calculated for bearing θₙ(0≤θₙ≤360) with a 360-degree system for marking bearings by using Equation (22).

$$θ {rad}_{n} = \{ \begin{matrix}( 90 - {θ}_{n} \text{/} 180 ) π , & if 0 \leq {θ}_{n} \leq 180 \\ ( {θ}_{n} - 270 \text{/} 180 ) π , & if 180 < {θ}_{n} \leq 360\end{matrix} \qquad ( 22 )$$

Herein, θₙ(n=1, 2, 3, . . . , N) represent N number of bearings that are divided from 0° to 360°, and π=3.14.

The SD data set {Xdataₙ,Ydataₙ} may be calculated as shown below.

$$\{ \begin{matrix}{Xdata}_{n} = {X}_{n} + {X}_{offset} \\ {Ydata}_{n} = {Y}_{n} + {Y}_{offset}\end{matrix} , \\ \{ \begin{matrix}{X}_{n} = {X}_{n} , & if 0 \leq {θ}_{n} \leq 180 \\ {X}_{n} = - {X}_{n} , & if 180 < {θ}_{n} \leq 360\end{matrix} \qquad ( 23 )$$

Herein, X_{offset} indicates an offset value (287.06 m) of the x-axis, and Y_{offset} indicates an offset value (864.27 m) of the y-axis.

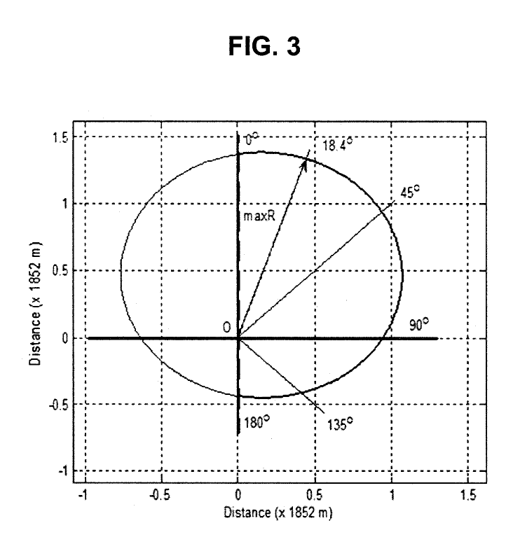

FIG. 3 illustrates a graph showing an SD by using {Xdataₙ,Ydataₙ}. The x-axis and the y-axis are distances indicated in units of 1852 m, and the space starting from the center (O) of the coordinates to the circle that is offset (or deviated) to a maximum distance (maxR) along an 18.4-degree(18.4°) direction becomes the ship domain (SD). In FIG. 3, a heading of a main ship (or own ship) is determined as 0°. Then, by applying a 360-degree system for marking bearings indicating up to 360° clockwise, a distance unit of 1,852 meters, which corresponds to 1.0 NM (wherein NM indicates an international nautical mile) is applied. In the present invention, a right-side circle of the SD, which is indicated in a bold line from 0° to 180°, is applied for performing a comparison analysis with the CR domain.

An Emotional Sensitivity (ES) data corresponds to data measuring a level of danger that is perceived by an OOW in a ship collision encounter situation by using a ship handling simulator.

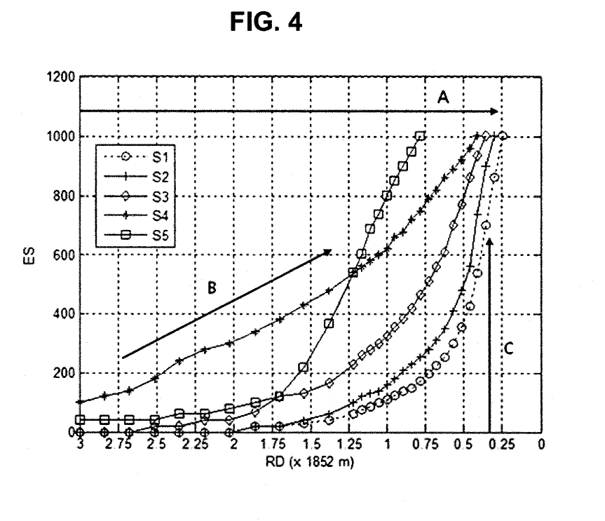

FIG. 4 illustrates a graph showing ES(0≤ES≤1,000) data corresponding to five different sampled ship collision encounter situations (S1˜S5).

FIG. 4 illustrates situations S1 to S5 where two ships encounter one another at relative bearings of 0°, 45°, 90°, 135°, and 180° and then collide with one another. The data of FIG. 4 corresponds to data being sampled by calculating ES values corresponding to relative distances that are differentiated from one another at predetermined intervals and by reducing the interval for the relative distances having a significant change in their ES values.

In FIG. 4, when compared with the other encounter situations, starting from the relative distance 0 m to the relative distance 1.75 (×1852) m, the ES value corresponding to S4 is always greater. However, after this point, the ES value of S5 becomes greater. Additionally, the relative distance reaching the maximum ES value is different for each of the five encounter situations. As shown in FIG. 4, the ES data may be represented by three different characteristics (A, B, and C). More specifically, A corresponds to a minimum relative distance indicating a maximum ES value, B corresponds to an aspect of transition (or change) between an increase and a decrease in the ES values respective to the relative distances, and C corresponds to an ES value respecting to the relative distance.

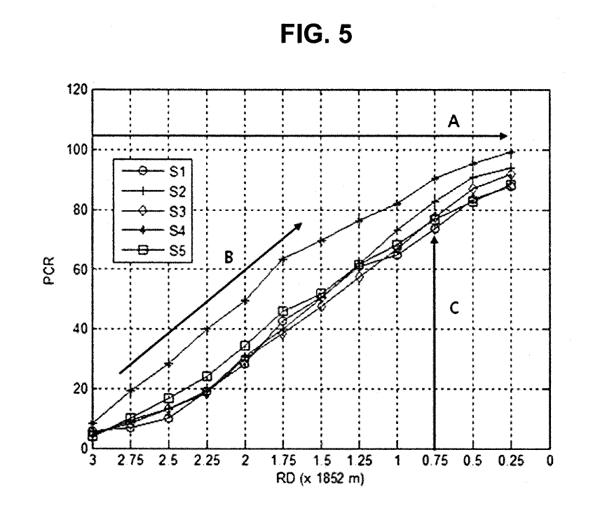

PCR data corresponds to data that is acquired by referring to a CRPI, which is measured in an actual naval vessel. FIG. 5 illustrates a graph showing PCR data that are measured for the five different ship collision encounter situations (S1˜S5). Herein, situations S1 to S5 correspond to situations where two ships encounter one another at relative bearings of 0°, 45°, 90°, 135°, and 180° and then collide with one another. Just as the ES data of FIG. 4, the PCR may also be represented by three different characteristics (A, B, and C).

The estimation results for the model variable of the CREM will now be described. Table 3 indicates \hat{γ}ᵢ and \check{σ}ᵢ, which are estimated by inputting the ES data and the PCR data to the CREM. In other words, Table 3 indicates estimated results for discrete relative bearings RBᵢ(i=1, 2, 3, . . . , I), which are estimated by using Equation (12) to Equation (16).

TABLE 3

| | | S1 | S2 | S3 | S4 | S5 |
|---|---|---|---|---|---|---|
| Data | Parameters | (i = 1) | (i = 2) | (i = 3) | (i = 4) | (i = 5) |
| ES | \hat{γ}ᵢ | −1.0 | −1.0 | −1.0 | −0.9 | −0.8 |
| | \check{σ}ᵢ | 2.6 | 3.1 | 5.0 | 12.7 | 4.3 |
| PCR | \hat{γ}ᵢ | −0.2 | −0.6 | −0.6 | −0.1 | −0.3 |
| | \check{σ}ᵢ | 9.7 | 9.3 | 9.2 | 12.6 | 0.3 |

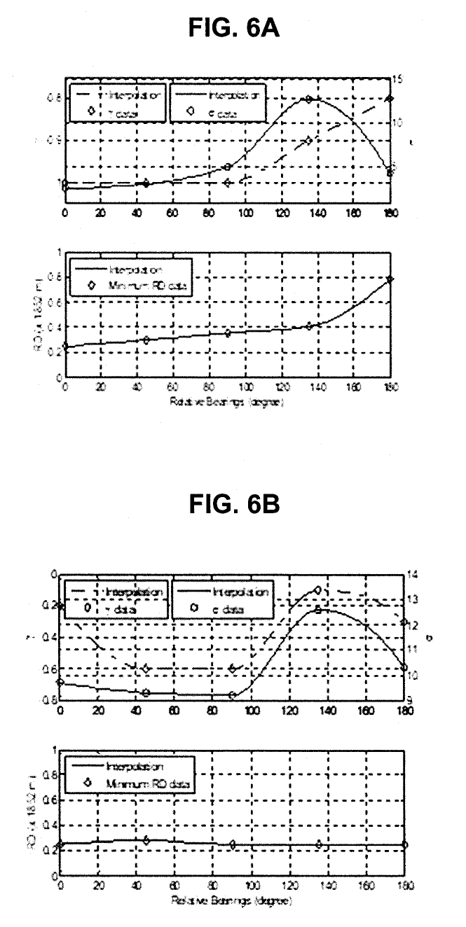

FIGS. 6A and 6B illustrate a graph showing estimated results for consecutive relative bearings RBᵤ(u=1, 2, 3, . . . , U), wherein the results correspond to calculation results of \tilde{γ}ᵤ, \tilde{σ}ᵤ, Min [symbol] ᵤ. FIG. 6A shows interpolation results for the ES data, and FIG. 6B shows interpolation results for PCR data.

Referring to the upper boxes of FIG. 6A and FIG. 6B, the changes in \tilde{γ}ᵤ and \tilde{σ}ᵤ are both significant near the relative bearing 135°. The lower box of FIG. 6A indicates that the Min [symbol] ᵤ increases starting from the relative bearing 0° to the relative bearing 180°. More specifically, this indicates that, as the relative bearing increases, the relative distance indicating a maximum ES value of 1,000 gradually decreases. The lower box of FIG. 6B indicates that the Min [symbol] ᵤ, which indicates a maximum PCR value, slightly increases near the relative bearing 45° and maintains a constant value throughout the remaining relative bearings.

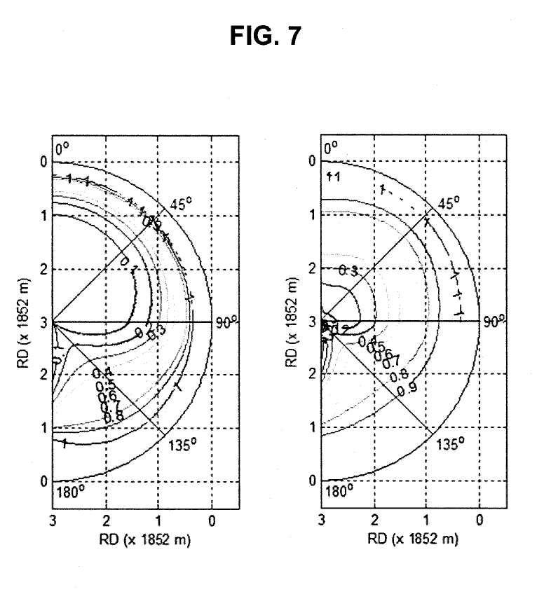

Meanwhile, the analysis results for the CR domain, which is estimated by the modeled CREM will hereinafter be described in more detail. FIG. 7 illustrates a graph showing a CR domain that is visualized by applying ES data and PCR data to the CREM. A contour line indicates [symbol] (0≤ [symbol] ≤1) being estimated for the relative bearings starting from 0° to 360°. Herein, [symbol] =0.0 indicates the lowest collision risk level, and [symbol] =1.0 indicates the highest collision risk level. In FIG. 7, the center of the coordinates is indicated as RD=3(×1852)m, which indicates that the main ship and its opposite ship are positioned at a greatest distance away from one another. This indicates that the relative distance between the two ships decreases as the two ships are positioned further away from the center of the coordinates.

In FIG. 7, the left-side graph represents a domain that is indicated by applying the ES data to the CREM, and the right-side graph represents a domain that is indicated by applying he PCR data to the CREM.

Referring to the ES data shown in the left-side graph of FIG. 7, a collision risk level is indicated near the relative bearing 135°, and a collision risk level of the same size corresponding to another relative bearing is indicated at a comparatively longer relative distance. For example, [symbol] =1.0 is indicated at approximately 1.0(×1852) m at the relative bearing 0°. However, near the relative bearing 135°, [symbol] =0.1 is indicated at approximately 3(×1852) m. More specifically, it is shown that, even though the relative distance between the main ship and its opposite ship is long (or great), the OOWs sense the ship encounter situation near the relative bearing 135° earlier than other ship encounter situations. And, it is also shown that, near the relative bearing 135°, an increase in the collision risk level from [symbol] =0.1 to [symbol] =1.0 occurs at a more or less consistent rate. This state is equally indicated in the PCR data shown in the right-side graph of FIG. 7. For example, when a ship encounter situation occurs near the relative bearing 90°, [symbol] =0.2 is indicated at approximately 2.2(×1852) m, and, when the ship encounter situation occurs near the relative bearing 135°, [symbol] =0.2 is indicated at approximately 2.8(×1852) m.

Therefore, in both the ES data and the PCR data, the same collision risk level is indicated earlier (or faster) in a ship encounter situation occurring at the relative bearing 135° as compared to a ship encounter situation occurring at another relative bearing.

Referring to the ES data shown in the left-side graph of FIG. 7, with the exception for the area near the relative bearing 135°, the collision risk level increases abruptly starting from a point where the relative distance is decreased to a predetermined level. For example, between the relative bearing of 0° and the relative bearing of approximately 90°, [symbol] =0.1 is indicated at a relative distance of approximately 1.0(×1852) m, and the collision risk level increases abruptly starting from [symbol] =0.1 to [symbol] =1.0. In an area near the relative bearing 135°, the collision risk level is indicated at a more or less consistent level, and, in an area near the relative bearing 180°, [symbol] =0.1 is indicated at a relative distance of 2.0(×1852) m, and [symbol] =1.0 is indicated near the relative distance of 1.0(×1852) m.

Conversely, in case of the right-side graph of FIG. 7, the collision risk level consistently increases in accordance with a decrease in the relative distance. Therefore, in case of the ES data, with the exception for the area near the relative bearing 135°, the collision risk level increases abruptly starting from a point where the relative distance decreases to a predetermined level. And, in case of the PCR data, the collision risk level is indicated to have a more or less consistent size in accordance with the relative distance.

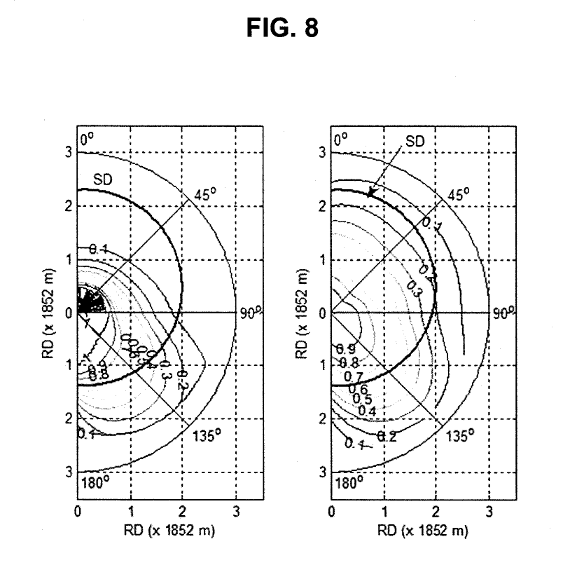

FIG. 8 illustrates a graph overlapping the SD and the CR domain in order to perform a comparison between the SD and an estimated CR domain.

FIG. 7 shows the center of the coordinates as 3(×1852)m, whereas FIG. 8 shows the center of the coordinates as 0 m. As described above, by defining the center of the coordinates as 0 m, the SD and the CR domain shown in FIG. 8 overlap one another. The SD shown in FIG. 8 has enlarged its SD radius to 2 times its initial size in order to facilitate the visual comparison between the SD and the CR domain.

In FIG. 8, the x-axis represents the relative distance starting from 0.0 m to 3.0(×1852)m, and the y-axis represents the relative distance along a vertical direction having 0.0 m as its center point. The contour line indicates the same [symbol] (0≤ [symbol] ≤1) starting from the relative bearing 0° to the relative bearing 180°. The outermost semi-circle of the contour line is arbitrarily connected to the relative distance 0.0 m.

The left-side graph of FIG. 8 illustrates the SD and the CR domain corresponding to the ES data. Herein, in a spatial aspect for collision avoidance, in case of the SD, a space between the relative bearing 0° and the relative bearing 90° is larger than a space between the relative bearing 90° and the relative bearing 180°. And, based on examination results of the SD data, the area near the relative bearing 30° indicates the longest (or greatest) relative distance. Conversely, in case of the CR domain corresponding to the ES data, [symbol] =0.1 is indicated at an area near the relative bearing 135° where the relative distance is longer than other relative bearings, and the space where the collision risk level is indicated is formed to have a larger area. In other words, although the SD is assigned with a larger space for a ship encounter situation near the relative bearing 30°, the CR domain corresponding to the ES data has a larger space indicating the collision risk level for a ship encounter situation near the relative bearing 135°.

The right-side graph of FIG. 8 illustrates the SD and the CR domain corresponding to the PCR data. In case of the CR domain, [symbol] =0.2 is indicated at an area near the relative bearing 135° where the relative distance is longer than other relative bearings. A space occupied by the collision risk near the relative bearing 135° does not indicate a particularly significant characteristic as compared to other relative bearings. Conversely, as compared to the SD, which occupies a large space near the relative bearing 30°, the CR domain is widely distributed near the relative bearing 135°.

The results of comparing the above-described SD with the CR domains using the ES and the PCR may be summarized as described below. In case of the SD and the CR domain for the ES data, although the SD is assigned with a larger space near the relative bearing 30°, in case of the CR domain, a larger collision level space is indicated near the relative bearing 135°. Similarly, in case of the SD and the CR domain for the PCR data, the distribution of the collision level is concentrated in the area near the relative bearing 135°. In case of both the CR domain for the ES data and the CR domain for the PCR data, each of the collision levels having the same size near the relative bearing 135° is indicated at a longer distance. Therefore, a larger space is assigned for the SD near the relative bearing 30°, and, in case of the CR domain for the ES data and the PCR data, the collision risk level is more widely distributed near the relative bearing 135°.

If the ES data and the PCR data corresponding to the CR domain are marked on the 3D coordinates by using the above-described modeled CREM, the results shown are opposite to those of the SD. More specifically, a large space is formed near the relative bearing 30° for the SD, and a larger perception space is formed near the relative bearing 135° for the CR domain. This indicates that a geological space of the SD for avoiding an actual (or real) ship collision is different from a psychological space of the CR, which is perceived by the OOW. And, therefore, this indicates that the psychological space of the OOW handling (or operating) the ship and the geological space for avoiding an actual ship collision should both be taken into consideration.

Hereinafter, an example of configuring (or setting up) a reference value for determining a collision risk and determining a collision risk by using the reference value will be described. The present invention uses two different types of reference values, which include a reference value corresponding to the spatial aspect and a reference value corresponding to the psychological aspect.

In order to set up the reference value corresponding to the spatial aspect, a reference distance for determining a risk of collision between two ships should be decided. In the present invention, a distance of the SD for a relative bearing is decided as a reference distance (DSD). Thereafter, when comparing the relative distance (RD) between two ships with the corresponding reference value, if the compared result indicates RD>DSD, it is determined that a risk of collision exists.

In order to set up the reference value corresponding to the psychological aspect, a reference value of a Collision Level (CL) for determining a risk of collision between two ships should be decided. In the present invention, among the CLs that are estimated by the above-described CREM, a CL corresponding to a reference distance (DSD), which is decided as a distance of the SD for the relative bearing, is decided as the reference value (CL(DSD)) of the collision level. Thereafter, the reference value corresponding to the psychological aspect is compared with a CL corresponding to the relative distance, i.e., the CL(RD), and, in case the compared result indicates CL(DSD)>CL(RD), it is determined that the collision risk level has exceeded the reference value.

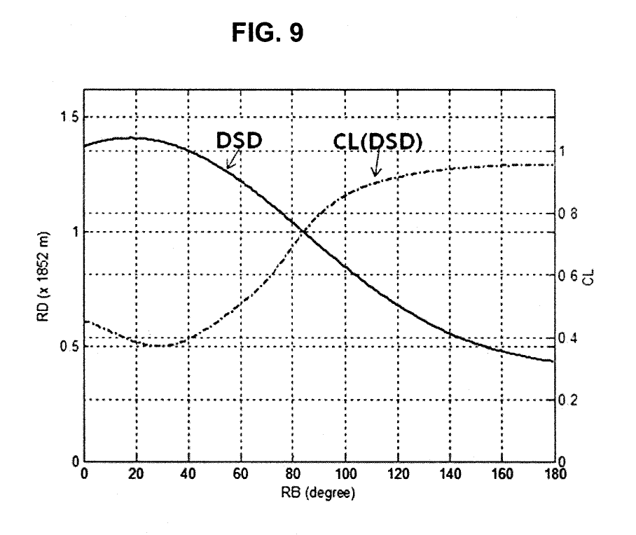

FIG. 9 illustrates a graph showing calculation results between a relative distance of a DSD and a CL(DSD). In FIG. 9, based on an area near the relative bearing of approximately 85°, the DSD and the CL(DSD) change in directions opposite to one another. The SD marks a maximum relative distance of 1.4 (×1852)m at the relative bearing 18.4° and marks a minimum relative distance of 0.4 (×1852)m at the relative bearing 180°. And, in case of the CR domain, the [symbol] marks a minimum value of 0.38 at the relative bearing 29°, and the [symbol] marks a maximum value of 0.96 at the relative bearing 177°. Accordingly, the DSD is a maximum relative distance at the relative bearing 18.4°, and the CL(DSD) marks a maximum collision risk level at the relative bearing 177°.

Hereinafter, a method for configuring a warning based on the results of determining collision risk by using a reference value will be described in detail.

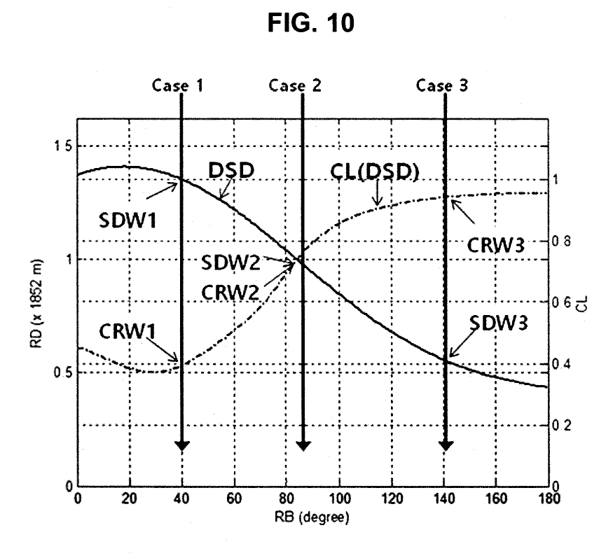

FIG. 10 illustrates a graph for describing a method of configuring a warning for notifying a collision risk by using a DSD and a CL(DSD) in a ship collision avoidance method using a psychological character of a ship officer according to the present invention.

Referring to FIG. 10, the present invention shows an example of configuring a warning according to three different situations (Case 1, Case 2, and Case 3).

Case 1: This corresponds to a case where the collision encounter situation between the main ship and the opposite ship occurs at a relative bearing of 40°. Herein, the relative distance between the two ships is decreased, and an SDW1 (hereinafter, this term will indicate an SD warning that is generated for the encounter situation of Case 1) is generated at the moment when the two ships pass the DSD. Thereafter, as the relative distance between the two ships continues to decrease, a CRW1 (hereinafter, this term will indicate a CR warning that is generated for the encounter situation of Case 1) is generated at the moment when the two ships pass the collision risk level of CL(DSD). Therefore, the OOW is capable of hearing the two warnings. Firstly, the OOW may acknowledge through the SDW1 that the relative distance between the two ships has decreased (or has become shorter) to a level that requires collision avoidance actions and may carry out ship handling actions for avoiding collision. If the OOW fails to carry out the collision avoidance actions, a second warning (CRW1) is generated so as to allow the OOW to acknowledge once again that a ship collision is imminent.

If the DSD as well as the CL(DSD) are applied, even though the OOW may have failed to carry out the collision avoidance actions because of using only the DSD, since the CRW1 is generated, another opportunity for carrying out the collision avoidance actions is given to the OOW not to mention that the OOW's level of attention (or alertness) may be increased. Accordingly, an accident that is caused by collision may be prevented.

Case 2: This corresponds to a case where the collision encounter situation between the main ship and the opposite ship occurs at a relative bearing of approximately 85°. In this case, when the relative distance between the two ships decreases, an SDW2 and a CRW2 are generated at the same time at the moment when the two ships pass the DSD and the CL(DSD). Since the warnings may notify the OOWs of the spatial distance that is required for avoiding collision as well as the danger level of collision risk, the attention and alertness of the OOWs may also be enhanced at the same time.

Case 3: This corresponds to a case where the collision encounter situation between the main ship and the opposite ship occurs at a relative bearing of approximately 140°. Characteristically, warnings are generated in an order that is opposite to that of Case 1. In this case, when the relative distance between the two ships decreases, a CRW3 is generated at the moment when the two ships pass the CL(DSD), thereby notifying the OOWs of the risk of a collision. Then, as the relative distance between the two ships continues to decrease, an SDW3 is generated at the moment when the two ships pass the DSD, thereby notifying the OOWs that it is presently a time (or moment) for carrying out the collision avoidance actions. Accordingly, by increasing the attention and alertness of the OOWs through the CRW3 before the OOWs carry out the collision avoidance actions, the failure to carry out the collision avoidance actions when the SDW3 is generated may be prevented.

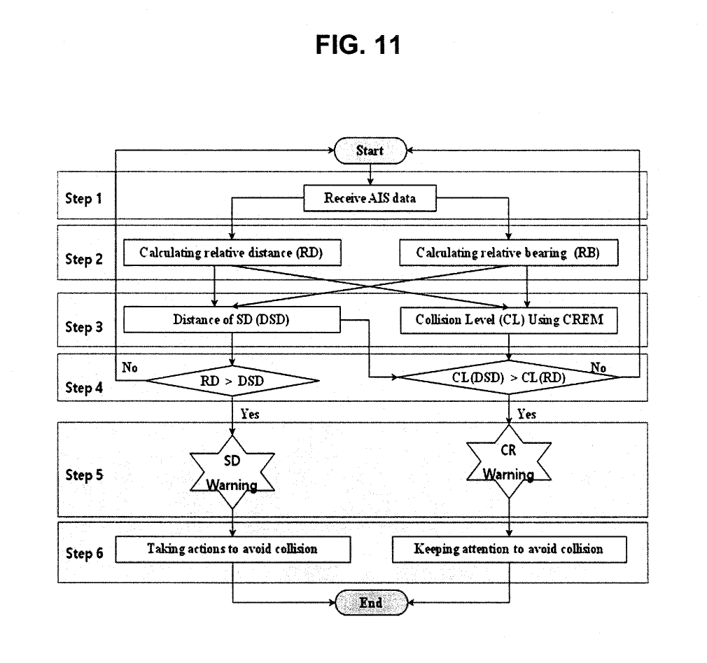

FIG. 11 illustrates a diagram showing a ship collision avoidance procedure using a psychological character of a ship officer according to an exemplary embodiment of the present invention. And, in the method according to the present invention, an Automatic Identification System (AIS) may be used.

Referring to FIG. 11, by using an AIS that is installed in the ship, information on an opposite ship (AIS data) is received (Step 1).

Thereafter, by using the information (AIS data) on the opposite ship and the information on the main ship, a relative distance (RD) and a relative bearing (RB) between the two ships are calculated (Step 2).

A collision level (CL) using a distance of the SD (DSD) and the modeled CREM is calculated (Step 3).

When comparing the RD with the DSD, if the RD is greater than the DSD, an SD warning notifying that the distance has a possibility of ship collision is generated (Step 4 and Step 5), and, then, appropriate collision avoidance actions (or operations) respective to the generated warning are performed (Step 6).

If the RD is not greater than the DSD, the above-described process steps (Step 1 to Step 3) are repeated.

Meanwhile, when further comparing the CL(DSD) and the CL(RD), if the CL(DSD) is greater than the CL(RD), a CR warning notifying that the collision risk level has exceeded the reference value is generated (Step 4 and Step 5), and, then, by concentrating a maximum level of attention, a situation perception level is increased (Step 6).

If the CL(DSD) is not greater than the CL(RD), the above-described process steps (Step 1 to Step 3) are repeated.

As described above, the ship collision avoidance method using a psychological character of a ship officer has the following advantages.

According to the present invention, since the ship domain theory and the psychological Collision Level (CL) of the officer on the watch (OOW) are used in combination, as compared to the conventional method, which only applies the ship domain theory, by reducing the probability of failing to carry out collision avoidance actions (or operations), the probability of achieving collision avoidance or collision prevention may be increased.

The reliability of the OOW's execution of collision avoidance actions (or operations) may be enhanced by using a plurality of warning functions using spatial and psychological ship collision domains.

Since the collision warning is generated necessarily and sufficiently as well as mutually between ships, it shall be possible to achieve an excellent collision avoidance through a combination of the OOW's acute attention and prompt collision avoidance actions.

Since the psychological aspect of the sense of collision risk felt by the OOW is applied to the collision avoidance method, human errors may be actively prevented.

A minimum distance required for carrying out the collision avoidance actions may be known, and the risk (or danger) of collision respective to the average relative bearing (RB) and relative distance (RD) that are perceived (or recognized) by the OOWs may also be known.

Since a physical space as well as a psychological space can be secured, the present invention may also be applied to the development of next generation navigation systems.

By applying the present invention to a traffic controller of a Vessel Traffic System (VTS), which is stationed on land, this may contribute to the prevention of accidents caused by a lack of attention and alertness of the traffic controllers. Most particularly, when the present invention is applied to a VTS that is required to control a plurality of ships at the same time, since the collision risk between the ships can be automatically reported (or notified) to the traffic controller, an active traffic support may be provided.

Although the present invention has been described according to the preferred exemplary embodiment of the present invention, it will be apparent to those skilled in the art that various modifications and variations can be made in this specification without departing from the spirit or scope of this specification.

Thus, it is intended that this specification covers the modifications and variations of this invention provided they come within the scope of the appended claims and their equivalents. It is also apparent that such variations of this specification are not to be understood individually or separately from the technical scope or spirit of this specification, and all differences lying within the scope of the appended claims and their equivalents should be interpreted as being included in the present invention.

What is claimed is:

1. As a method providing support for avoiding collision between ships by using a psychological character of a ship officer in a situation of an imminent collision, a ship collision avoidance method using a psychological character of a ship officer, comprising:
a first step calculating a relative distance (RD) and a relative bearing (RB) between two ships by using information of a main ship and information of an opposite ship;
a second step estimating a collision risk level (or collision level) (CL) corresponding to the relative distance (RD) and the relative bearing (RB) by using a collision risk (CR) perception of the ship officer, and modeling a Collision Risk Estimation Model (CREM) that converts the estimated results to three-dimensional (3D) coordinate data;
a third step calculating a distance of a ship domain (DSD) and the collision level (CL) using the modeled Collision Risk Estimation Model (CREM);
a fourth step deciding a reference value of a spatial aspect corresponding to a reference distance for determining a presence of a collision risk between two ships and a reference value of a psychological aspect corresponding to a collision level (CL) for determining a presence of a collision risk between two ships; and
a fifth step comparing the relative distance (RD) with the reference value corresponding to the spatial aspect, so as to generate a ship domain (SD) warning for notifying the ship officers that the two ships are within a distance of a possible collision, or comparing a collision risk corresponding to the relative distance (CL(RD)) with the reference value corresponding to the psychological aspect, so as to generate a collision risk (CR) warning for notifying the ship officers that the collision level has reached a level of collision risk.

2. The method of claim 1, wherein, in the fourth step, a distance of a ship domain (DSD) corresponding to the relative bearing (RB) is decided as the reference value corresponding to the spatial aspect.

3. The method of claim 1, wherein, in the fourth step, among the collision levels (CLs) estimated by the Collision Risk Estimation Model (CREM), a collision level (CL) corresponding to a distance of a ship domain (DSD) (CL(DSD)) corresponding to the relative bearing (RB) is decided as the reference value corresponding to the psychological aspect.

4. The method of claim 1, wherein, in the fifth step, the relative bearing (RB) is compared with the reference value corresponding to the spatial aspect, and, if the relative distance (RD) is greater than the reference value corresponding to the spatial aspect, the ship domain (SD) warning is generated.

5. The method of claim 1, wherein, in the fifth step, the collision risk corresponding to the relative distance (RD) (CL(RD)) is compared with the reference value corresponding to the psychological aspect, and, if the reference value corresponding to the psychological aspect is greater than the collision risk corresponding to the relative distance (RD) (CL(RD)), the collision risk (CR) warning is generated.

6. The method of claim 1, wherein, in the second step, input variables of the Collision Risk Estimation Model (CREM) include the relative bearing (RB) and the relative distance (RD), and output variables of the Collision Risk Estimation Model (CREM) include the collision levels (CLs) of the collision risk (CR) being estimated for consecutive relative bearings (RBs) and relative distances (RDs).

7. The method of claim 6, wherein, in the second step, the output variables of the Collision Risk Estimation Model (CREM) further include coordinate values for indicating the collision levels (CLs) on a three-dimensional (3D) hybrid map.

8. The method of claim 6, wherein, in the second step, the Collision Risk Estimation Model (CREM) estimates the collision level (CL) corresponding to the input variables by using a probability density function (pdf) of a Generalized Extreme Value (GEV).
